(19) United States
(12) Patent Application Publication
(10) Pub. No.: US 2013/0074799 A1
(43) Pub. Date: Mar. 28, 2013

(54) Piston pin unload for oil film renewal

(71) Applicant: PATRICK A. KOSHELEFF, YANKEE HILL, CA (US)

(72) Inventor: PATRICK A. KOSHELEFF, YANKEE HILL, CA (US)

(21) Appl. No.: 13/200,243

(22) Filed: Sep. 22, 2011

(51) Int. Cl. F16C 7/00

(52) U.S. Cl. 123/197.3

(57) ABSTRACT

In a reciprocating engine piston, added equipment to renew the piston pin's oil film once per crankshaft rotation. The equipment is located between the connecting rod's small end and the underside of the piston crown. There is a plunger carrier with a plunger, and a saddle with a plunger bore. The saddle closely straddles the plunger carrier, maintaining the alignment of the arcuate plunger with the arcuate plunger bore, for a plunger stroke without friction. The small end's natural oscillation during crankshaft rotation powers the plunger's working cycle. There is an oil-filling stroke and a delivery stroke. The delivery is to the saddle's top, which is just below the piston crown. The oil pressure pushes upward on the piston crown, lifting the piston slightly and the piston pin bosses off the piston pin. In the small gap thus created, new oil can enter, recreating the oil film.

### BACKGROUND OF THE INVENTION

U.S. Pat. No. 3,056,638 for a reciprocating engine creates a recurring small gap below the piston pin to renew the oil film. It discloses a piston-and-connecting rod assembly. The upper end (the “small end”) of the connecting rod is shaped not round but slightly eccentric to the axis of the piston pin. Once per crankshaft revolution, the eccentric meshes with a concave surface under the piston crown. This is caused by the natural oscillation of the connecting rod as its angularity changes continually during crankshaft rotation. The bulging portion of the eccentric acts as a cam when it passes under the concave surface, pushing up on it. The piston moves up slightly, as do the piston pin bosses. They pull the piston pin upward a little, creating increased clearance to the bushing in the rod small end. A renewal oil film can penetrate the increased clearance between the bottom of the pin and the bottom of the bushing. This restores the oil film between the piston pin and the bushing.

Our invention also unloads the piston pin, but the implementation is different. Hydraulic pressure is used to push upward on the bottom of the piston crown. The result is also different: The clearance obtained is between the piston pin and the piston pin bosses.

U.S. Pat. No. 3,027,207 will achieve the same result, but mechanically. The action is almost identical to that of U.S. Pat. No. 3,056,638 above. Clearance for a renewal oil film was not claimed, however, because his intent was direct bearing of the piston head on the connecting rod.

U.S. Pat. No. 3,200,798 for a variable compression ratio piston has an oil pumping action somewhat close to our own. A raised bump on the connecting rod small end pushes on a pump plunger. Pressurized oil is sent upward into a chamber under the moveable piston crown, causing it to lift. Quite similar to our mechanism. But his raised bump works as a cam, which is subject to wear. The push on our plunger is aligned with the back of the plunger.

In U.S. Pat. No. 2,066,489 the wear limitation is decreased by an arm pushing on the pump plunger. However, most of the contact includes sliding. An improvement is the arm shaped as a gear tooth. This has rolling contact at the pitch radius of mesh, a likely place for the point of highest load, therefore a good thing. But sliding wear remains at the other points.

### SUMMARY OF THE INVENTION

A reciprocating engine piston with added equipment above the connecting rod and below the piston crown. The ultimate goal of the invention is to renew the oil film at the top of the piston pin once per revolution of the crankshaft. The proximate goal is to lift the piston slightly, using oil at high pressure pushing up on the bottom of the piston crown. This will cause the piston pin bosses to lift off the piston pin, creating a small gap between them through which refill oil can enter.

In one embodiment, the new equipment includes:
1) a plunger carrier with an arcuate plunger,
2) a fixed saddle with an arcuate plunger bore,
3) an upstanding post on the connecting rod's small end, and
4) a shallow bore in the underside of the piston crown.

The plunger carrier is located atop the small end of the connecting rod and is attached to the upstanding post. The plunger carrier oscillates back and forth in tune with the small end. The saddle straddles the plunger carrier but does not move. The saddle's plunger bore accommodates the working stroke of the plunger. There is a check valve upstream of the plunger bore.

In operation, the plunger reciprocates within the plunger bore once per revolution of the crankshaft. On the outstroke, the plunger draws in some engine oil admitted by the check valve, filling the plunger bore. On the in-stroke, the check valve closes and the plunger delivers the captive oil under high pressure to the shallow bore in the underside of the piston crown. Check valve opening and closing are controlled by the reversing inertial forces generated by piston acceleration and deceleration during its travel.

The top of the saddle fits closely in the shallow bore. The highpressure oil pushes the piston crown upward slightly. The piston pin bosses are part of the piston structure, so they move up too. A small gap opens up between them and the piston pin, allowing oil to enter and renew the oil film.

The plunger and the plunger bore are circular arcs, for a mesh without friction. Close clearances between saddle and plunger carrier maintain plunger alignment. The upstanding post is loosely attached to the plunger carrier in the sideways direction, in order to allow normal side play of the connecting rod.

A reinforcing web is added to the plunger, and a strongback behind them braces both. The strongback connects to the plunger carrier, making the entire assembly more rigid. The refill oil is routed directly to the plunger bore through a slot milled in its floor. The top of the plunger carrier then functions as a moving floor, blocking by close clearance the leakage from the slot.

In a second embodiment, the upstanding post and the shallow bore are eliminated. The plunger carrier is a ridge fixed to the connecting rod's small end. The plunger, shaped like a circular arc, lies flat on the curved top of the plunger carrier. The piston crown is simplified, having a flat underside. Now both the plunger carrier and the saddle move a little from side to side when the connecting rod exercises its small end play. One advantage of a plunger carrier fixed to the small end is that it eliminates the interface between them. One less clearance reduces the stacked clearances of the assembly. A different seal to the piston crown can be used: A slight raised rim at the top of the saddle may contain the oil pressure against the underside of the piston crown enough for it to lift.

### BRIEF DESCRIPTION OF THE VIEWS

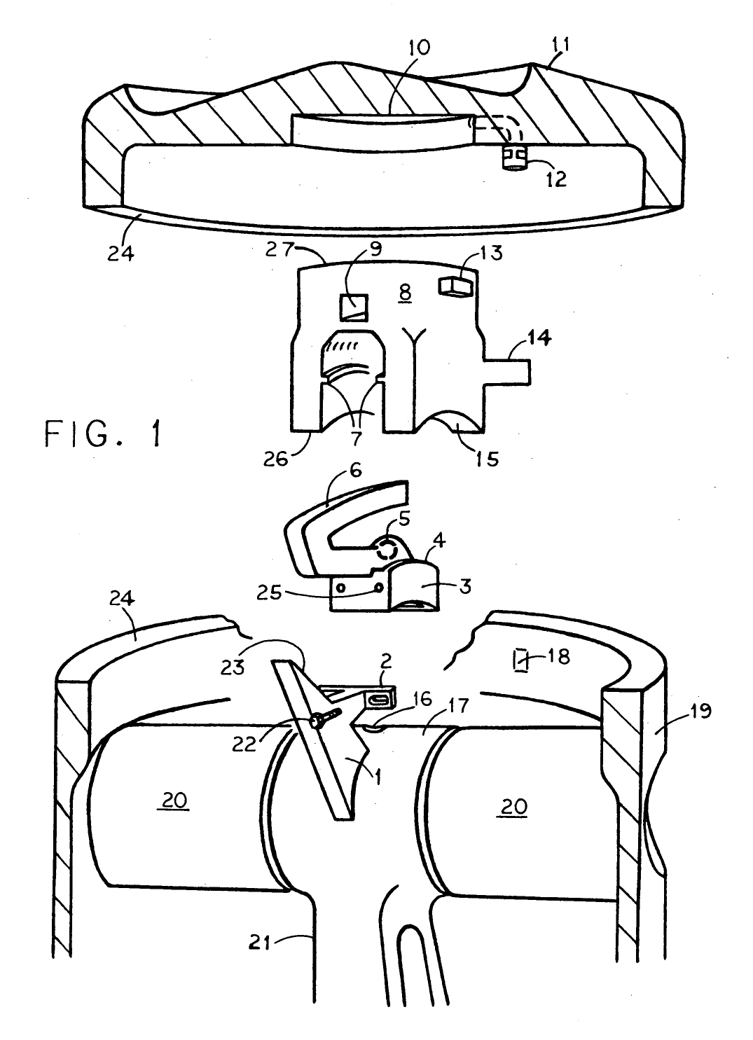

FIG. 1 is a cutaway and exploded elevation of an engine piston and connecting rod assembly plus the new parts.

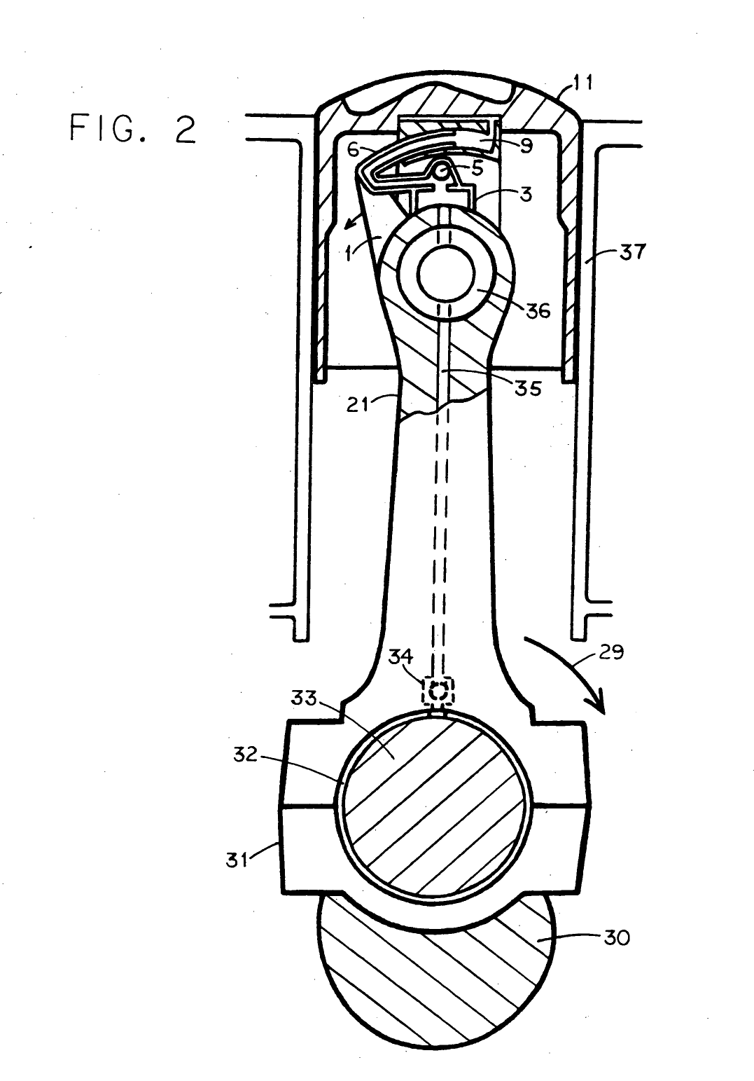

FIG. 2 is a partly sectional elevation of the new parts in action, with the engine components at Top Dead Center (“TDC”).

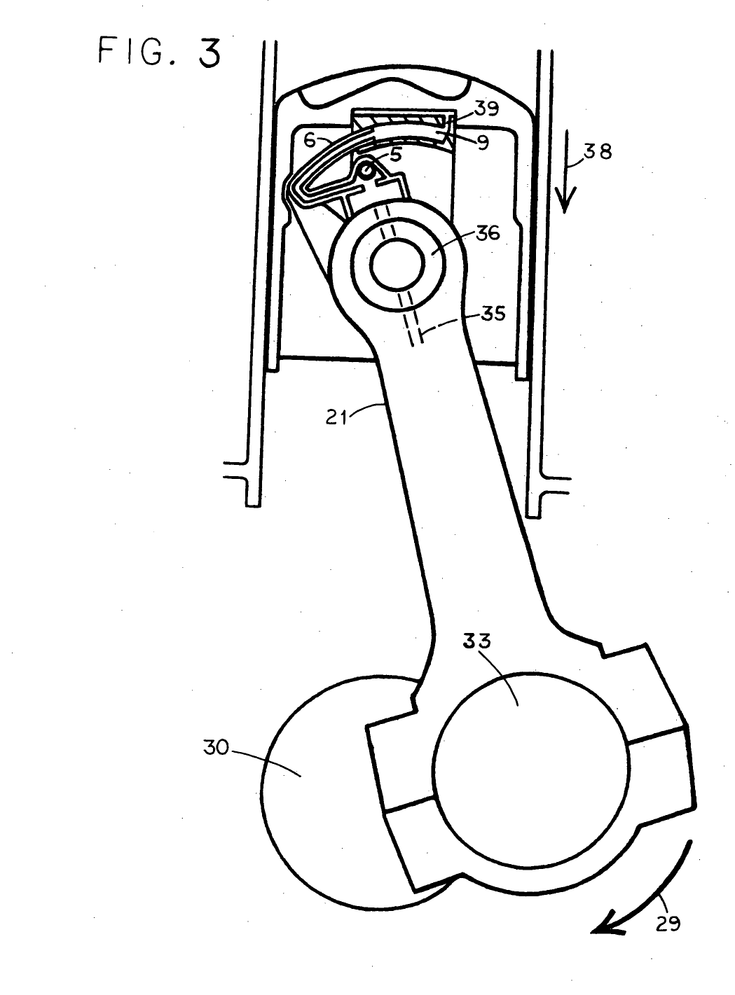

FIG. 3 is similar to FIG. 2 but at 80° after TDC.

FIG. 4 is similar to FIG. 2 but at 180° after TDC.

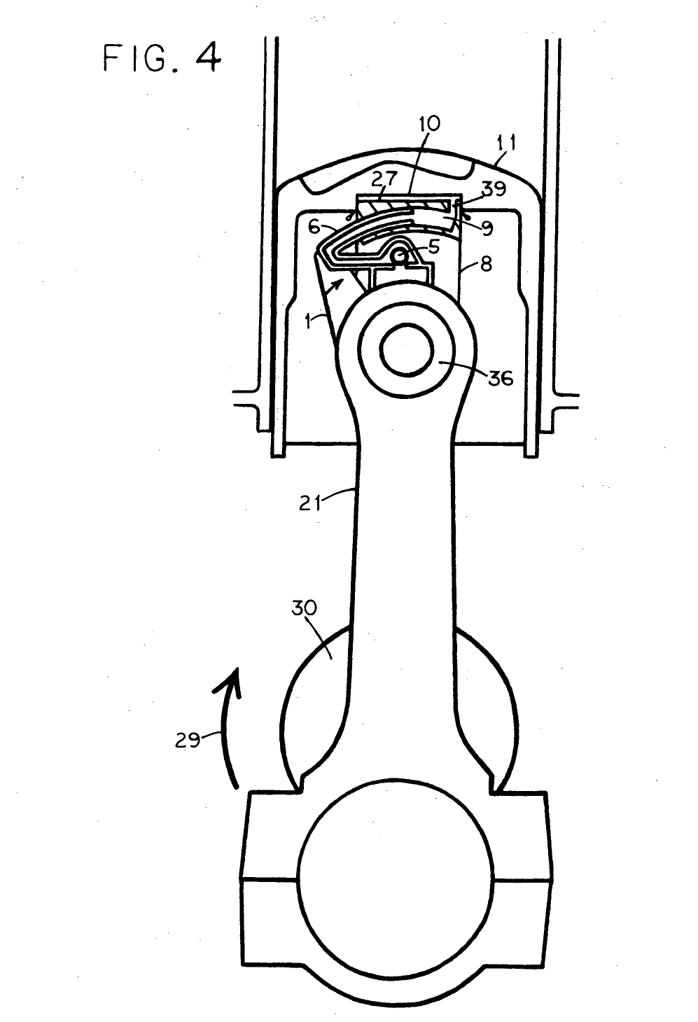

FIG. 5 is similar to FIG. 2 but at 270° after TDC.

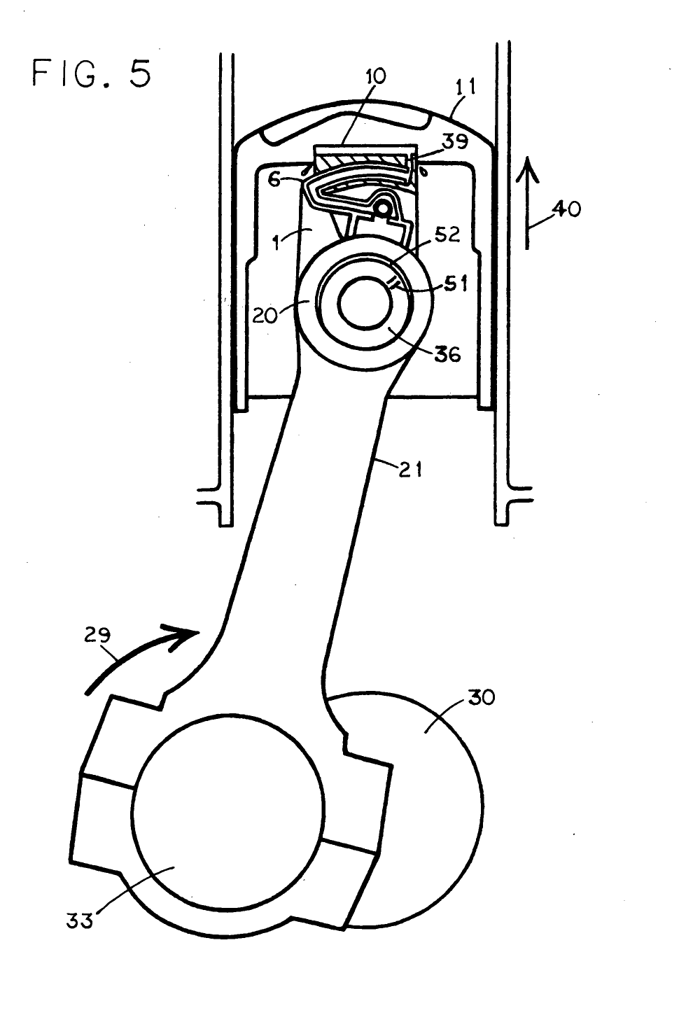

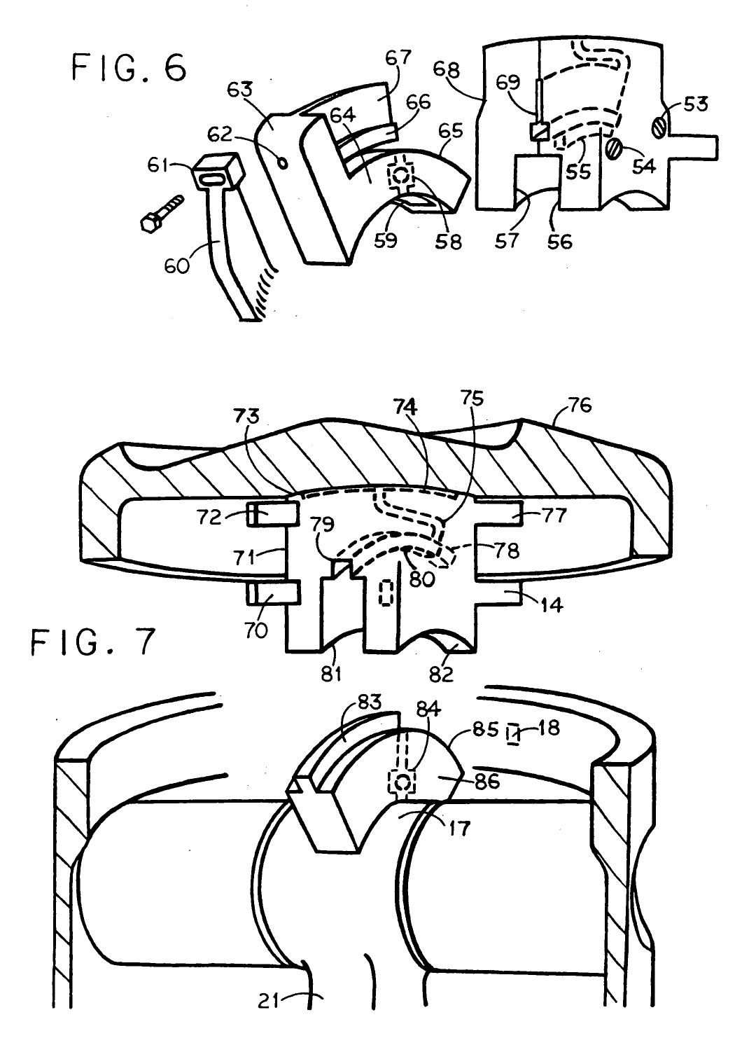

FIG. 6 is an elevation of a strengthened plunger and plunger carrier, plus necessary changes to the saddle.

FIG. 7 is an elevation of a plunger solidly fixed to the small end, and a new saddle top's sealing method against the piston crown.

### DETAILED DESCRIPTION

FIG. 1 starts with a cutaway view of an engine piston 11, 19. The piston has been sliced into two pieces at parting line 24, mainly to expose the underside of piston crown 11. Piston skirt 19 has been sawed vertically, and the near half removed, to show the piston pin bosses 20 and the top 17 of connecting rod 21. The piston itself is almost unchanged from conventional ones, the only difference being shallow bore 10 in piston crown 11. Shallow bore 10 is sized to closely house top deck 27 of saddle 8, one of the new parts. The other new part is plunger 6, whose simple shape is useful for visualizing the action. It will be greatly changed for more strength in FIGS. 6 and 7.

Some background on reciprocating engines follows. A piston pin is usually coated with a thin “squeeze film” of lubricating oil between it and the piston bosses such as 20. In operation, the oil film compresses under load, protecting the parts. The invention aims to assist the periodic renewal of the oil film. This is especially useful in 2-stroke cycle engines with a high degree of boost. The working gas pressure on piston crown 11 never relaxes completely, eventually pushing the oil film out of existence. High wear is the result. The invention will physically lift the piston pin bosses 20 very slightly off the piston pin, allowing oil to enter the gap.

Some equipment to do that is seen in FIG. 1 as a plunger 6 which sweeps a plunger bore 9 of the same arcuate shape. Sweeping is preferably done with close clearance between plunger 6 and plunger bore 9, without friction. Plunger 6 will deliver oil under high pressure to saddle topside 27. Topside 27 doesn't move, but since it is contained in shallow bore 10, the piston crown 11 will move upward a little instead. The piston pin bosses 20 will move up too, attaining the object of the invention. To be seen in FIGS. 2-5.

That is the method. Next, it is verified that the new parts can be assembled together. First, the piston alone and the connecting rod are set aside. Assembly begins with saddle 8 and plunger carrier 3 held in the right and left hand respectively. Plunger 6 is started in plunger bore 9. The left hand is rotated clockwise until plunger 6 is contained in plunger bore 9. Then curved ramp 4 should be just under right-most ridge 7, the whole making a compact block. The block is set directly over oil hole 16 at the top of rod small end 17. Machine screw 22 passes through ear 2 and tightens into threaded hole 25. A second screw (not shown) should be used on the other side of post 1. Now the block is attached to upstanding post 1. Now spike 23 would be directly behind the reverse bend of plunger 6, ready to push on the plunger later, during operation. Next, connecting rod 21 with the block is inserted into piston skirt 19 from below. Small end 17 passes between piston pin bosses 20 until the position shown in FIG. 1. By that time, saddle top deck 27 should have entered bore 10 in piston crown 11. The assembly is completed by inserting a piston pin (not shown) into piston pin bosses 20 in the conventional manner. Attention turns to the mechanics of the new equipment. The most important consideration is the motion of the parts. Plunger carrier 3 sits on top of small end 17. Carrier 3 is attached to upright post 1 which is integral with connecting rod 21. Thus, plunger carrier 3 shares the ongoing oscillation of small end 17 during crankshaft rotation. The rhythmic motion of plunger 6 back and forth in plunger bore 9 is the pumping action which makes the invention work. Triangular spike 23 fits snugly against the back of plunger 6 and does the actual pushing of plunger 6 opposed by high oil pressure. To be seen in FIGS. 2-5.

Saddle 8 of FIG. 1 is practically immobile. Uprights 15 and 26 have curved bearing surfaces at the feet which slide smoothly over oscillating top 17 of rod 21 as it rocks underneath. Thus, rod top 17 must be machined round accurately. Rod top 17 is smooth all the way across, not just for sliding saddle 8's two bearing surfaces, but for a close fit to the underside of plunger carrier 3. Carrier 3 captures engine oil coming out of oil hole 16, so there must be a good seal. Carrier 3 is an imitation of the “oil transfer slipper” in FIG. 9 of Society of Automotive Engineers (“SAE”) Paper 660344 (also in SAE Transactions.) One difference is that carrier 3 is not held in place by a spring, but by curved ridges 7 in saddle 8. The one on the right holds down curved ramp 4. Tab 13 (one of two) bottoms on the underside of piston crown 11 and holds down saddle 8. The text now switches to how the invention works. FIGS. 2-5 show the plunger in action.

FIG. 2 includes the piston, connecting rod and crankshaft assembly. Piston 11 is at Top Dead Center (“TDC”) in cylinder 37. Conventionally, this is at zero degrees of rotation of crankshaft main bearing journal 30. The big end 31 of connecting rod 21 is riding around rod bearing journal 33 (crankpin 33.) Some new equipment is foot valve 34, copied from previously cited FIG. 9 of SAE 660344. Foot valve 34 admits part of the lubricating oil which was ducted to rod bearing 32 through the usual drilled holes (not shown) in the crankshaft. The oil, under pressure from the engine's oil pump, rises past foot valve 34 and up vertical duct 35, again imitating FIG. 9 of SAE Paper 660344. The oil crosses drilled piston pin 36 and enters the cavity of plunger carrier 3. Ear 2 and machine screw 22 of FIG. 1 have been left out of the drawing, to avoid clutter. Plunger 6 is assumed to be attached to, and follow the motions of, upright post 1 in FIGS. 2-5.

As piston 11 rides up and down cylinder 37, its displacement versus time describes a type of Simple Harmonic Motion. In this well-known trajectory, a repeating sine curve, the piston speed goes to zero for an instant at TDC, but the acceleration is greatest. That's because the motion is being reversed. In consequence, ball 5 of the main check valve hangs high, off its seat. The open valve lets the oil continue onward. It flows to the left and up through hollow plunger 6. Connecting rod 21 pivots on piston pin 36. With crankpin 33 rotating to the right (arrow 29), upright post 1 is swinging to the left (small arrow.) Post 1 pulls plunger carrier 3 and plunger 6 with it. Plunger 6 is leaving plunger bore 9, creating new volume behind the plunger. The oil keeps going and fills that volume too. This is the refill portion of the plunger cycle.

FIG. 3 shows rod journal 33 at eighty degrees of rotation past TDC. Because of the angularity of connecting rod 21, the piston displacement versus time is only approximately Simple Harmonic Motion, but its conclusions are still valid. Piston speed 38 is the highest, and acceleration is near zero. In other words, the piston is coasting at high speed (arrow 38.) Ball 5 of the main check valve has no cause to move from its high perch yet, although that will soon change. But for now, plunger 6 has retracted the maximum out of plunger bore 9. Oil has filled plunger bore 9. This ends the refill duration.

FIG. 4 shows the piston at Bottom Dead Center, 180 degrees of crankshaft journal 30 rotation beyond TDC. In the reverse of FIG. 2, in FIG. 4 upright post 1 is now moving to the right (small arrow.) Post 1 pushes on plunger 6 before it. The volume of plunger bore 9 decreases. The oil cannot flow backward because check valve ball 5 has dropped to its seat. This is because of the deceleration of the piston. Referring to Simple Harmonic Motion again, the piston is momentarily stopped, but the downward acceleration is greatest (motion reversal.)

With backflow blocked, the captive oil in plunger bore 9 flows up duct 39 and is delivered to topside means of saddle 8, namely top deck 27. Between top deck 27 and the floor of shallow bore 10 is a cavity full of oil. Oil pressure pushes equally on floor 10 and top deck 27. Saddle 8 can't move, so piston crown 11 starts to move upward very slightly instead. (It is noted that plunger 6 may have been sized much larger, for visibility's sake, than it needs to be to pump enough oil to move piston crown 11 incrementally. In any case, a small movement is the proximate goal of the invention.) FIG. 4 shows the middle of the working stroke of plunger 6.

FIG. 5 shows the parts at the three-quarters point of one complete revolution of crankshaft journal 30. Rod journal 33 is 270 degrees of rotation beyond FIG. 2. In FIG. 5, piston 11 is “coasting” upward (arrow 40) at high speed. An important visual change is that ringshaped item 20 is a piston pin boss, not part of connecting rod 21. Upright post 1 is at the end of its movement to the right. Plunger 6 is similarly at the end of its stroke. The oil, formerly in plunger bore 9 in FIG. 3, has now been completely pushed out through duct 39 and into shallow bore 10. Completing the action in FIG. 4, steady push on floor 10 has moved piston crown 11 upward visibly now (some 0.002″ in reality.) Piston pin boss 20 is an integral part of the piston and moved up slightly too. A small gap 52 (again 0.002″) appears between piston pin boss 20 and the top of piston pin 36. This is the goal of the invention. The oil film between piston pin boss 20 and piston pin 36 can renew itself through gap 52.

Capillary action on the usual oil mist rising from the crankcase is the most common way to renew this oil film. But pressure feed is also possible, using small hole 51 drilled in piston pin 36. Two small holes 51, actually, one for each piston pin boss 20. It is recalled that the interior of piston pin 36 must already be under pressure in order to convey upward the oil in oil duct 35 of FIG. 2.

It should be noted that the gas loads are already of some magnitude in FIG. 5, where compression of the charge on the up-stroke of the piston has already started. Therefore, the oil pressure inside bore 10 may have to be quite high to move the piston even just a minute amount opposed by the gas load on piston crown 11. Two things can now be observed.

First, the gas load of compression may be so large at the point of FIG. 5 that the oil film was actually rebuilt in FIG. 4, not FIG. 5. This is easily achieved. FIG. 4 is where the gas load is the smallest. That's because the gas load is only the boost pressure, not the compression pressure. Thus, gap 52 from FIG. 5 may quite reasonably appear in FIG. 4 instead. The timing of events shown in FIGS. 4 and 5 should not be interpreted too literally. Oil-filled gap 52 seen in FIG. 5 may in fact be squeezing down from compression gas load by the time of FIG. 5. It will not matter. Squeeze film action on a piston pin is a well-tested phenomenon.

Secondly, the pumped oil could reach very high pressure, but can't be allowed to break something. In FIG. 1, a solution is to add a conventional spring-loaded pressure relief valve 12.

There are sizeable reaction forces on saddle 8. In FIG. 4, plunger 6 is pumping oil out of plunger bore 9 against great resistance from oil pressure. There will be a strong push on saddle 8 toward the right. At the top of saddle 8, that load is easily handled by the side wall of shallow bore 10 pushing against top deck 27. At the bottom of saddle 8, in FIG. 1 a solution is strut 14 reaching right to contact patch 18 on the inside wall of piston skirt 19. That absorbs directly the lower portion of the push to the right on saddle 8. This desired result depends on strut 14 making constant contact with patch 18 without interfering with the slight upward motion (about 0.002″) of the piston when gap 52 seen in FIG. 5 is being created. With lubrication from the usual oil mist, it seems doable.

Small motions matter considerably in this invention. The next one, in FIG. 1, is caused by the side clearance between connecting rod small end 17 and the piston pin bosses 20. Connecting rod 21 moves from side to side a little during normal operation. This slight motion has to be accommodated by saddle 8 and plunger carrier 3. Saddle 8 can't move to the side because top-deck 27 is inserted into shallow bore 10. There is no problem. Small end 17 is machined smooth and just slides sideways under saddle upright surfaces 15 and 26. For plunger carrier 3, it's the same in one way and different in another. Carrier 3 also has concave mating surfaces at the bottom, therefore small end 17 just slides sideways under it too. However, carrier 3 is attached to upright post 1 by machine screw 22 etc. This attachment must be kept loose. Machine screw 22 may bottom in threaded hole 25, to lock the screw, but the head of machine screw 22 must leave a small clearance to ear 2. Then the elongated slot in ear 2 allows post 1 to move side-to-side without dragging carrier 3 with it. Thus, the side play of connecting rod small end 17 is intended to be independent of carrier 3 operation. Consequently, a plunger carrier is defined to be relatively fixed with respect to small end 17's normal rocking oscillation: The side play is simply ignored. A subtle point is that the tiny looseness of machine screw 22 not clamping down on ear 2 is also ignored.

On the other hand, the mechanical consequences of the side play cannot be dismissed. The trouble is caused by metal-to-metal friction between spike 23 and the reverse bend of plunger 6. The slot in ear 2 is a geometric fix but not a physical remedy. When plunger 6 is in its working stroke, pumping oil against high pressure, spike 23 will press hard against plunger 6. From physics, pressure on a contact joint increases friction. Spike 23 would have trouble sliding left or right to follow the connecting rod's side play. Oil mist rising up from the crankcase will help with lubrication; still, the friction might pull plunger 6 to the side. Plunger 6 would bend inside plunger bore 9, an unacceptable situation.

At this point, it's necessary to abandon the components 1-9 seen in FIG. 1. Post 1, carrier 3, plunger 6, and saddle 8 are gone, replaced one-for-one by the parts in FIG. 6. The new parts can cope with the friction problem. The only reason the old parts were used was for clear viewing in FIGS. 2-5: The simple shapes from FIG. 1 made it easy to follow the oil flow path and the action in FIGS. 2-5. If the stronger but more complicated parts from FIG. 6 had been drawn instead, FIGS. 1-5 would have been hard to follow. But the new parts from FIG. 6 do work the same as those from FIG. 1.

Material presented three paragraphs ago on the sideways sliding of small end 17 below a plunger carrier and a saddle is still valid. The topic returns to material of two paragraphs ago, but now it's friction between new post 60 and the wall in back of new plunger 66. In FIG. 6, the friction situation actually is between slot piece 61 and the area of strongback 63 around threaded hole 62. Upright post 60 replaces upright post 1 of FIG. 1. In FIG. 6, new plunger 66 is backed by web 67 and both are attached to strongback 63. Since strongback 63 morphs smoothly into plunger carrier 64, the whole entity can be considered the plunger carrier. The sides of plunger carrier 64 will be closely clasped by cheek faces 56 and 57 of new saddle 68. That stops plunger carrier 64 from moving side-to-side. Strongback 63 won't move side-to-side either. Since plunger 66 is solid with strongback 63, any sideways motion of plunger 66 should be greatly reduced. Plunger 66's alignment with plunger bore 69 will be more secure.

As before, the machine screw can bottom in threaded hole 62, to lock the screw, but leaving a slight clearance to slot piece 61. That allows the side play of now post 60 fixed to the connecting rod. But the amount of friction remains. Slot piece 61 might have to be hardened against wear, or pressure-lubricated to reduce friction. It seems achievable. We drop the topic of accommodating connecting rod side play.

The new parts in FIG. 6 are further explained. In FIG. 4, pumping of the oil by plunger 6 was smoothly accomplished, geometrically speaking, because the circular-arc shapes of plunger 6 and plunger bore 9 are easily machined and should glide past each other without friction during mesh. But the reaction force on plunger 6 from oil pressure is straight, not curved. That force will try to open up the reverse bend of plunger 6, possibly breaking it. Plunger 6 has needed to be heavily reinforced all along.

In FIG. 6, a thin web 67 is added to plunger 66, thereby making in effect half of an I-beam. Saddle 68's plunger bore 69 is re-configured to accept the different cross-section. Web 67 is itself a pumping member, so it is drawn quite thin to avoid increasing the pumping work too much. However, no limitation on its thickness is implied. Web 67 is the main reason for the new parts in FIG. 6, because a web is the only-practical way to keep a cantilevered plunger like plunger 6 of FIG. 1 from bending under load.

Strongback 63 rigidly positions plunger 66 and web 67 with respect to plunger bore 69. It does this by angling forward to, and being integral with, plunger carrier 64. Carrier 64 will sit on rod small end 17 of FIG. 1. In FIG. 6, carrier 64's top surface 65 will be held down by the ceiling of the large opening between the uprights (56 and 57.) That, plus the clasping of the sides of carrier 64 by faces 56 and 57 previously mentioned should secure the alignment of plunger 66 in plunger bore 69.

Manufacturing saddle 68 is best done by halves, as suggested by the drawing. A plunge pass of a fly cutter (not shown) can machine one half of plunger bore 69 in each half, then the two saddle halves are bolted together by machine screws 53 and 54. The back of the cuts for plunger bore 69 is then sealed by a plug (not shown) of appropriate cross section.

Applicable to the material for FIG. 6 covered so far, the parts in FIG. 6 function in conjunction with piston 11, 19, 20 of FIG. 1, plus connecting rod 21 of FIG. 1 but without upstanding post 1.

In FIG. 6, the oil circuit which will end up filling plunger bore 69 can be improved from the oil circuit in FIGS. 1 and 2. First, hollow plunger 6 as in FIGS. 2-5 is replaced by a solid plunger 66. Then a more direct path for the oil is devised. Check valve 58 similar to check valve 34 of FIG. 2 is installed just above oil hole hollow opening 59 in plunger carrier 64. A short duct is seen just above check valve 58. When plunger carrier 64 and saddle 68 are meshed together, the short duct connects to a slot 55 milled out of the floor of plunger bore 69. Thus, a short flow path is established for oil to enter plunger bore 69. This applies to the filling process corresponding to FIGS. 2 and 3. In FIG. 6, the potential major leakage path for the oil represented by slot 55 is blocked by close-fitting surface 65. Now plunger 66 can be solid, not hollow, for more strength.

Threaded hole 62 is up high, so that slot piece 61's push is directly behind plunger 66 and web 67. Any lower location for hole 62 would cause plunger carrier 64 to try to tilt upward. This is because of high pressure oil's resistance to plunger travel. Then there would be higher wear on carrier 64's top surface 65.

Finishing up FIG. 6, the assembly procedure for its parts follows the model for the components of FIG. 1 presented earlier.

A second preferred embodiment of the invention is next.

FIG. 7's parts perform the same function as the parts in FIG. 6 (pumping oil to the saddle's top) but several things are different. Plunger carrier 86 is a curved ridge fixed with respect to small end 17, and plunger 83 is a curved rib fixed to the top of plunger carrier 86. Now the rigidity of plunger 83 is a certainty. Saddle 71's plunger bore 79 doesn't have a floor, but is clearance-sealed against massive leakage by the curved top surface 85 of plunger carrier 86. Saddle 71 is stronger because it is one-piece. Plunger bore 79 and the large cavity below it can be made in one pass of a cutter wheel (not shown.) To finish plunger bore 79, an arcuate plug at location 78 is inserted at the end of the cut for bore 79 in order to seal it there.

To assemble the parts, piston crown 76 and saddle 71 are brought straight down until plunger carrier 86 fills the cavity between uprights 81 and 82. Then plunger 83 fits plunger bore 79. Clearly, the cross sections of all these parts have to mesh with close clearance. This is both to block leakage and to keep the parts aligned. The most critical clearance is where top surface 85 comes close to the open bottom arc 80 of plunger bore 79 to seal the opening. More details will follow later.

Plunger carrier 86 is shown integral with small end 17, but might just be solidly attached. Either way removes one degree of freedom from the whole assembly. The former clearance interface between plunger carrier 3 and small end 17 in FIG. 1 (or plunger carrier 64 of FIG. 6 and small end 17 of FIG. 1) is gone. There is less “slop” in the assembled components of FIG. 7. This will confer an advantage. To begin, it is observed that new saddle 71 now has to move left and right along with plunger carrier 86. In other words, when small end 17 exercises its side play. Saddle movement is a major change, but saddle 71 simply slides under the now-flat underside of piston crown 76. At all other times saddle 71 is practically immobile. Saddle 71 just sits there while small end 17 rocks back and forth under uprights 81 and 82, and plunger 83 pumps oil out of plunger bore 79.

The advantage conferred by fewer separate pieces is that it's easier to maintain tight clearance overall. Then top deck 73 of new saddle 71 may just abut the flat underside of piston crown 76. Shallow pan 74 would distribute the pressure of oil coming up duct 75 evenly on the flat surface. Close clearance between raised rim 73 and the flat bottom of piston crown 76 would be the sealing method. Then, fortuitously, the desired 0.002″ upward-movement of piston crown 76 might be its own pressure release safety valve.

Contrasting FIGS. 6 and 7 thus far, in FIG. 6 plunger carrier 64 and saddle 68 don't move from side to side, but in FIG. 7 plunger carrier 86 and saddle 71 do move side-to-side as connecting rod 21 exercises its side play.

The apparatus and operation of the new topside means 73-74 of new saddle 71 are examined. A shallow pan 74 is carved out of the top of saddle 71. This leaves the narrow raised rim 73 which makes a complete circle around shallow pan 74. Rim 73 is what comes close to the flat bottom of piston crown 76. Duct 75 which lets the oil under high pressure out of plunger bore 79 discharges the oil at the center of shallow pan 74. Then the oil will flow outwardly and, it is hoped evenly, in all radial directions toward raised rim 73, where it will leak out slowly. The continuous radial outflow of oil in all directions of the compass suggests that no oil will linger very long in shallow pan 74. Therefore, the oil should avoid being cooked by prolonged exposure to the temperature of piston crown 76.

Since saddle 71 is not held by bore 10 of FIG. 1, in FIG. 7 some more bracing struts 70, 72 and 77 are added to hold saddle 71 in place. Strut 14 (same as in FIG. 1) and strut 77 brace saddle 71 against the push to the right caused by high oil pressure on the back end of plunger bore 79. Struts 70 and 72 keep saddle 71 from moving forward when plunger 83 retracts. This fore-and-aft bracing renders saddle 71 essentially immobile relative to the piston in a direction at right angle to the axis of oscillation of small end 17.

In FIG. 7, plunger carrier 86 will-be closely clasped by the two uprights 81 and 82 of saddle 71. Thus, when plunger carrier 86 moves left or right as a result of connecting rod 21's side play, new saddle 71 will move the same amount. This helps keep plunger 83 centered in plunger bore 79. Plunger 83 itself can he integral with plunger carrier 86, or just fastened to it. The downside of FIG. 7 is that saddle 71 represents a sizeable mass to move left or right during small end 17's side play. Therefore, the necessity of a high plunger carrier 86 so that tall side face 86 can push on the whole of upright 82. With a uniform push on fully half the height of saddle 71, there's a good chance saddle 71 will move left or right smoothly without scraping or tipping.

FIG. 7 shows a preferred oil flow path. Check valve 84 is inside plunger carrier 86. The oil to refill plunger bore 79 flows upward directly. The entire bottom arc 80 of the floor of plunger bore 79 was simply machined away. It leaves a long, narrow opening in the large cavity's ceiling for oil to enter. The potential huge leakage path of the opening is blocked by the width of carrier top surface 85, which at all times spans the large cavity between uprights 81 and 82. Thus, the three walls of square cross-section channel 79, plus top surface 85 making the fourth wall, constitute the plunger bore. The whole plunger-swept volume is still contained in channel 79, which saves the characterization of saddle 71 as containing the plunger bore.

The planned small clearance between top surface 85 and the ceiling of the large cavity between uprights 81 and 82 will allow some small leakage. This will lubricate the moving parts, for instance carrier side wall 86 sliding past the inside wall of upright 82.

The floor missing from plunger bore 79 will cause an upward push on saddle 71 from hydraulic pressure. However, the area of shallow pan 74 is much greater than the area of plunger bore 79. There will be a net downward push on saddle 71 which keeps it firmly planted on small end 17, thereby helping keep plunger 83 and plunger bore 79 aligned. Minor topics follow.

Oil duct 35 in FIG. 2 could be a tube (not shown) on the outside of connecting rod 21, to preserve the rod's beam strength.

Check valve 34 in FIG. 2 may not be needed; it's not claimed.

Some piston crowns are more complicated than our simple shape 11 in FIG. 1. There may be deep bowls for combustion, two-piece pistons, etc. In general, then, piston crown means.

Highly-boosted four-stroke cycle engines weren't mentioned, but they are not excluded from the invention.

“Plunger means” are defined to include a plunger and any structure which holds it or connects it to the rod's small end. “Upstanding post” is any sizeable boss on a connecting rod's small end. “Small end” is defined not by size but by enclosing the piston pin at its center.

The Claims refer to the parts in FIGS. 6 and 7. FIG. 6 is in conjunction with piston crown 11, and connecting rod 21 as in FIG. 1 but with upstanding post 1 replaced by upstanding post 60 of FIG. 6.

The scope of the invention is found in the appended claims.

1. A reciprocating engine piston and connecting rod assembly with added means to renew the oil film atop the piston pin once per revolution of the crankshaft; said means to renew located substantially between the small end of said connecting rod and the bottom means of the piston crown means; said means to renew including:
(1) plunger means connected to or integral with said small end and rocking back and forth substantially the same as the normal oscillation of said small end; said plunger means including an arcuate plunger; and
(2) a saddle containing an arcuate plunger bore and substantially immobile in a direction perpendicular to the oscillation axis of said small end; said saddle straddling a portion of said plunger means, with narrow clearances in order to establish and maintain close alignment of said plunger in said plunger bore;
said piston pin partly disposed through said small end and partly contained in piston pin bosses; said piston pin bosses fixed with respect to said bottom means; said saddle having foot means resting on said small end oscillating underneath;
during said crankshaft's rotation, said rocking of said plunger means powering the strokes of said plunger; oil constituting working fluid for said plunger; said oil flowing toward said plunger bore under control of upstream check valve means; said plunger stroking arcuately back and forth within said plunger bore;
said plunger on the outstroke allowing intake of said oil into said plunger bore while said check valve means are held open by the upward inertial force on said piston during the top half of rotation of said crankshaft; said plunger on the in-stroke pumping said oil to higher pressure while said check valve means are held closed by the downward inertial force on said piston during the bottom half of rotation of said crankshaft; said oil at said higher pressure delivered through opening means to topside means of said saddle;
said topside means located adjacent said bottom means of said piston crown means; and said oil under said higher pressure pushing up on said bottom means, lifting said piston crown means, and lifting said piston pin bosses slightly off said piston pin; thereby creating a small gap above said piston pin for renewal oil to enter.

2. The device of claim 1 and two more components:
(3) an upstanding post fixed with respect to said small end and partaking in said normal oscillation of said small end; said post being part of said plunger means and transmitting said rocking ultimately reaching said plunger; and
(4) a shallow bore in said bottom means of said piston crown means; said shallow bore containing said topside means of said saddle in close clearance, thereby substantially immobilizing said saddle and creating volume means between said topside means and the floor of said shallow bore;
said plunger aligned in said plunger bore by plunger carrier means; said plunger carrier means including a plunger carrier located on said small end and a strongback connecting said plunger carrier to said plunger; said plunger carrier being arcuate; said plunger's curvature substantially paralleling the curvature of said plunger carrier but with space between them; said strongback substantially transverse to said plunger carrier and bridging said space to said plunger;
an arcuate web integral with said arcuate plunger and reinforcing it; said web together with said plunger pumping in expanded said plunger bore; one end of said web integral with said strongback;
said web, said plunger, said strongback, and said plunger carrier together forming a unitary entity substantially rigid against the bending of said plunger caused by the resistance of said oil under said higher pressure;
said oil under said higher pressure delivered to said volume means for said pushing up on said bottom means of said piston crown means;
and said post attached to the back of said strongback to power said stroking, but said post held loosely in a sideways direction, in order to allow side-to-side motion of said small end during said connecting rod's normal side play.

3. The device of claim 1 in which said plunger means include a plunger carrier; said plunger carrier being a ridge fixed with respect to said small end; the top surface of said ridge being arcuate, with a curvature substantially the same as said plunger; said plunger being a slender rib integral with, or attached to, said top surface of said ridge; said foot mean& of said saddle including two uprights flanking a central cavity of substantially the same transverse cross section as that of said ridge; said cavity having ceiling means at the top; said plunger bore curving contiguous above said ceiling means; the floor of said plunger bore being absent at said ceiling means; thereby forming together with said cavity a composite opening accepting said ridge and said rib with narrow clearances; part of said top surface of said ridge forming moving floor means for said absent said floor of said plunger bore, thereby completing the volumetric entity of said plunger bore; said ridge and said saddle having sideways motion substantially the same as the normal side play of said connecting rod; said bottom means of said piston crown means having flat area means substantially above said topside means, to accommodate its said sideways motion; and strut means extending from said saddle to the inside wall of said piston's skirt; said strut means oriented to prevent movement of said saddle caused by said oil at said higher pressure pushing on the end wall of said plunger bore.
